(19) United States
(12) Patent Application Publication
(10) Pub. No.: US 2015/0043251 A1
(43) Pub. Date: Feb. 12, 2015

(54) POWER CONVERSION SYSTEM AND METHOD OF CONTROLLING POWER CONVERSION SYSTEM

(71) Applicant: TOYOTA JIDOSHA KABUSHIKI KAISHA, Toyota-shi (JP)

(72) Inventor: Takahiko HASEGAWA, Toyota-shi (JP)

(73) Assignee: TOYOTA JIDOSHA KABUSHIKI KAISHA, Toyota-shi (JP)

(21) Appl. No.: 14/451,792

(22) Filed: Aug. 5, 2014

(30) Foreign Application Priority Data
Aug. 7, 2013 (JP) 2013-164358

(51) Int. Cl. H02M 1/34; H02M 3/335

(52) U.S. Cl. CPC H02M 1/34; H02M 3/33507; H02M 2001/346
USPC 363/21.12

(57) ABSTRACT

A power conversion system includes a first switching DC-DC converter circuit including a first switching device, a second switching DC-DC converter circuit connected in parallel with the first switching DC-DC converter circuit and including a second switching device, and a snubber capacitor connected in parallel with each of the first switching device and the second switching device. The power conversion system is configured such that a frequency of driving the first switching DC-DC converter circuit is higher than a frequency of driving the second switching DC-DC converter circuit, and an equivalent series inductance of a closed circuit including the first switching device and the snubber capacitor is smaller than that of a closed circuit including the second switching device and the snubber capacitor.

### INCORPORATION BY REFERENCE

The disclosure of Japanese Patent Application No. 2013-164358 filed on Aug. 7, 2013 including the specification, drawings and abstract is incorporated herein by reference in its entirety.

### BACKGROUND OF THE INVENTION

1. Field of the Invention

The invention relates to a power conversion system including switching DC-DC converter circuits and method of controlling a power conversion system.

2. Description of Related Art

In order to increase the capacity (or output) of a DC-DC converter and reduce the size of the DC-DC converter, for example, two or more DC-DC converter circuits may be connected in parallel, and parallel driving of two or more phases of the DC-DC converter circuits may be performed (see, for example, Japanese Patent Application Publication No. 2002-233151 (JP 2002-233151 A).

In this case, a snubber capacitor, or the like, for suppressing surge is often located in each of the switching DC-DC converter circuits connected in parallel, so as to suppress surge voltage generated between both ends of a switching device included in the DC-DC converter circuit when the switching device is turned off (see, for example, JP 2002-233151 A).

If the snubber capacitor is provided for each of the DC-DC converter circuits connected in parallel, the number of components is increased, and the size of the DC-DC converter is increased. Therefore, it may be proposed that the two or more DC-DC converter circuits share a common snubber capacitor.

However, where the DC-DC converter circuits share the snubber capacitor, the capacitance, location, etc. of the snubber capacitor cannot be optimized for each of the DC-DC converter circuits; therefore, a switching loss caused by the surge voltage may be increased, and the efficiency may be reduced.

### SUMMARY OF THE INVENTION

The invention provides a power conversion system having two or more phases of switching DC-DC converter circuits connected in parallel, which system is operable with improved efficiency when the DC-DC converter circuits share a snubber capacitor.

A power conversion system according to a first aspect of the invention includes a first switching DC-DC converter circuit including a first switching device, a second switching DC-DC converter circuit connected in parallel with the first switching DC-DC converter circuit and including a second, switching device, and a snubber capacitor connected in parallel with each of the first switching device and the second switching device. The first switching DC-DC converter circuit, the second switching DC-DC converter circuit, and the snubber capacitor are configured such that a frequency of driving the first switching DC-DC converter circuit is higher than a frequency of driving the second switching DC-DC converter circuit, and an equivalent series inductance of a closed circuit including the first switching device and the snubber capacitor is smaller than an equivalent series inductance of a closed circuit including the second switching device and the snubber capacitor.

A method of controlling a power conversion system according to a second aspect of the invention is a method of controlling a power conversion system including a first switching DC-DC converter circuit including a first switching device, a second switching DC-DC converter circuit connected in parallel with the first switching DC-DC converter circuit and including a second switching device, and a snubber capacitor connected in parallel with each of the first switching device and the second switching device. According to the method, when at least one of the first switching DC-DC converter circuit and the second switching DC-DC converter circuit is driven, one of the first switching DC-DC converter circuit and the second switching DC-DC converter circuit including, as a part thereof, a closed circuit having a smaller equivalent series inductance, which is selected from a closed circuit including the first switching device and the snubber capacitor, and a closed circuit including the second switching device and the snubber capacitor, is preferentially driven.

A power conversion system according to a third aspect of the invention includes a first switching DC-DC converter circuit including a first switching device, a second switching DC-DC converter circuit connected in parallel with the first switching DC-DC converter circuit and including a second switching device, and a snubber capacitor connected in parallel with each of the first switching device and the second switching device. The first switching DC-DC converter circuit, the second switching DC-DC converter circuit, and the snubber capacitor are configured such that an equivalent series inductance of a closed circuit including the first switching device and the snubber capacitor is substantially equal to an equivalent series inductance of a closed circuit including the second switching device and the snubber capacitor.

According to the first, second and third aspects of the invention, it is possible to provide the power conversion system having two or more phases of switching DC-DC converter circuits connected in parallel, which system is operable with improved efficiency when the DC-DC converter circuits share a snubber capacitor, and also provide the method of controlling the power conversion system.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a circuit diagram of a DC-DC converter according to a first embodiment of the invention;

FIGS. 2A and 2B are circuit diagrams each showing the configuration of a DC-DC converter circuit (corresponding to one phase) included in the DC-DC converter according to the first embodiment;

FIGS. 3A, 3B and 3C are views useful for explaining surge voltage generated in a switching device included in the DC-DC converter circuit;

FIG. 4 is a schematic view indicating the positional relationship between DC-DC converter circuits and a snubber capacitor according to the first embodiment;

FIG. 5 is a view indicating the efficiencies of the DC-DC converter circuits according to the first embodiment;

FIG. 6 is a schematic view indicating the positional relationship between DC-DC converter circuits and a snubber capacitor according to a second embodiment of the invention; and

FIG. 7 is a circuit diagram of a DC-DC converter according to a modified example.

### DETAILED DESCRIPTION OF EMBODIMENTS

Some embodiments of the invention will be described with reference to the drawings.

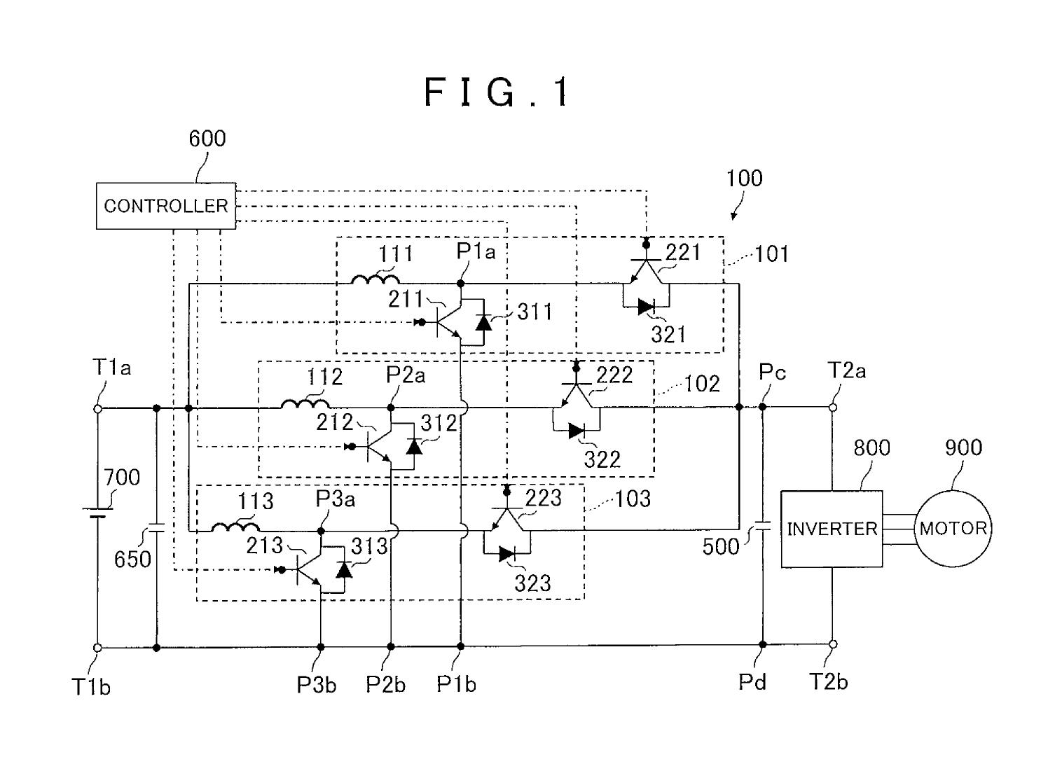

FIG. 1 is a circuit diagram of a DC-DC converter 100 according to a first embodiment of the invention. For example, the DC-DC converter 100 may be installed on an electric vehicle, such as a hybrid automobile, or an electric automobile.

The DC-DC converter 100 is provided between a battery 700 and an inverter 800. The DC-DC converter 100 raises the voltage of electric power supplied from the battery 700, and supplies the electric power to a motor 900 that drives the electric vehicle, via the inverter 800. When the electric vehicle is in a condition where the accelerator pedal is released (OFF), the motor 900 is driven with energy received from the wheels, to thus perform regenerative power generation, and the regenerative electric power thus generated is supplied to the DC-DC converter 100 via the inverter 800. In this case, the DC-DC converter 100 drops the voltage of the regenerative electric power, and supplies the resulting power to the battery 700. As a result, the battery 700 is charged with the power received from the DC-DC converter 100. In the following description, an operating mode in which the DC-DC converter 100 raises voltage may be called “step-up mode”, and an operating mode in which the DC-DC converter 100 drops voltage may be called “step-down mode”.

The DC-DC converter 100 includes a pair of input terminals T1a, T1b, a pair of output terminals T2a, T2b, three DC-DC converter circuits 101, 102, 103 connected in parallel between the pair of input terminals T1a, T1b and the pair of output terminals T2a, T2b, a snubber capacitor 500, a controller 600, a smoothing capacitor 650, and so forth.

The DC-DC converter circuits 101, 102, 103 have the same configuration, and are connected in parallel with each other. Each of the DC-DC converter circuits 101, 102, 103 is a non-isolated DC-DC converter circuit called “step-up chopper” (in the case where it operates in the step-up mode) or “step-down chopper” (in the case where it operates in the step-down mode).

The DC-DC converter circuit 101 includes two switching devices 211, 221, a reactor 111, two diodes 311, 321, and so forth. The DC-DC converter circuit 102 includes two switching devices 212, 222, a reactor 112, two diodes 312, 322, and so forth. The DC-DC converter circuit 103 includes two switching devices 213, 223, a reactor 113, two diodes 313, 323, and so forth.

Each of the reactors 111, 112, 113 is a passive device capable of generating a magnetic field using electric current flowing therethrough, and storing magnetic energy. Also, each of the reactors 111, 112, 113 has a characteristic (constant current characteristic) with which it tends to keep current constant. For example, when a certain switching device is turned off, and a pathway through which electric current has flowed is cut off, the reactor keeps current flowing through another pathway. The DC-DC converter circuits 101, 102, 103 utilize the above-described function so as to raise the voltage of electric power supplied from the battery 700 via the pair of input terminals T1a, T1b, and drop the voltage of regenerative electric power supplied via the pair of output terminals T2a, T2b, as will be described later.

The switching devices 211, 221, 212, 222, 213, 223 are switching means on which the controller 600 performs ON/OFF control. For example, power switching devices, such as power MOSFET (Metal Oxide Semiconductor Field Effect Transistor), and IGBT (Insulated Gate Biplolar Transistor), may be used as the switching devices 211, 221, 212, 222, 213, 223.

The diodes 311, 321, 312, 322, 313, 323 are rectifying devices, and free-wheeling diodes, etc., may be used as the diodes 311, 321, 312, 322, 313, 323.

The constituent elements included in the DC-DC converter circuit 101 are connected in the manner as described below. The DC-DC converter circuits 102, 103 have the same configuration as the DC-DC converter circuit 101, and therefore, will not be described herein.

The reactor 111 is connected at one end (one terminal) thereof to the positive electrode of the battery 700 via the input terminal T1a. The reactor 111 is connected at the other end (the other terminal) to a collector terminal of the switching device 211 and an emitter terminal of the switching device 221 via a connection point P1a.

The collector terminal of the switching device 221 is connected to one terminal of the snubber capacitor 500 and the output terminal T2a via a connection point Pc. The output terminal T2a is connected to one terminal of the inverter 800.

The output terminal T2b connected to the other terminal of the inverter 800 is connected to an emitter terminal of the switching device 211 and the input terminal T1b via a connection point P1b. The input terminal T1b is connected to the negative electrode of the battery 700.

The anode of the diode 311 is connected to the emitter terminal of the switching device 211. The cathode of the diode 311 is connected to the collector terminal of the switching device 211. Namely, the diode 311 is arranged in parallel with the switching device 211 such that the diode 311 passes current in a direction (forward biased direction) from the emitter terminal toward the collector terminal.

The anode of the diode 321 is connected to the emitter terminal of the switching device 221. The cathode of the diode 321 is connected to the collector terminal of the switching device 221. Namely, the diode 321 is arranged in parallel with the switching device 221 such that the diode 321 passes current in a direction (forward biased direction) from the emitter terminal toward the collector terminal.

The operation, such as specific flow of electric current, in the DC-DC converter circuits 101, 102, 103 will be described later.

The snubber capacitor 500 is provided for suppressing surge voltage across both ends of each switching device included in each of the DC-DC converter circuits 101, 102, 103 when the switching device is turned off. Since an inductance component is included in wire traces, etc. of a current pathway through which current passes when the switching device is in the ON state, energy stored in the inductance component cannot be released anywhere after the switching device is turned off, and is applied as surge voltage between the both ends of the switching device, as will be described in greater detail. When the switching device is turned off, the snubber capacitor 500 is able to recirculate the energy stored in the inductance component so as to suppress the surge voltage. The snubber capacitor 500 is connected in parallel with the DC-DC converter circuits 101, 102, 103 (the switching devices 211, 221, 212, 222, 214, 223 included in the respective DC-DC converter circuits 101, 102, 103), and is shared among the DC-DC converter circuits 101, 102, 103 for suppression of the surge voltage. The snubber capacitor 500 is connected at one terminal thereof to the output terminal T2a, and is connected at the other terminal to the output terminal T2b.

The controller 600 is a control device that performs drive control on the DC-DC converter 100. When the DC-DC converter 100 operates in the step-up mode, the controller 600 performs ON/OFF control on each of the switching devices 211, 212, 213 of the DC-DC converter circuits 101, 102, 103, so as to control the voltage between the output terminals T2a, T2b. When the DC-DC converter 100 operates in the step-down mode, the controller 600 performs ON/OFF control on each of the switching devices 221, 222, 223 of the DC-DC converter circuits 101, 102, 103, so as to control the voltage between the input terminals T1a, T1b. More specifically, the controller 600 has a gate drive circuit that generates a gate drive voltage to a gate terminal of each switching device, and performs the ON/OFF control by transmitting an ON/OFF drive signal from the gate drive circuit to each switching device. Also, the controller 600 receives a value of voltage between the output terminals T2a, T2b and a value of voltage between the input terminals T1a, T1b from voltage sensors (not shown), or the like, and controls the duty ratio, etc. of the above-indicated ON/OFF drive signal, through feedback control based on each of the voltage values.

The controller 600 also performs control for changing the number of DC-DC converter circuits to be driven, according to the load (including output load and regenerative load) of the motor 900. For example, when the electric vehicle of this embodiment runs in a steady-state mode, electric power required to drive the motor 900 is relatively small; therefore, the controller 600 causes one or two of the three DC-DC converter circuits 101, 102, 103 to be driven. When the electric vehicle starts being accelerated (when it is in a transient state), electric power required to drive the motor 900 becomes relatively large; therefore, the controller 600 causes all of the three DC-DC converter circuits 101, 102, 103 to be driven. When the electric vehicle is decelerated at a relatively small rate, regenerative electric power received from the motor 900 is relatively small; therefore, the controller 600 causes one or two of the three DC-DC converter circuits 101, 102, 103 to be driven. When the electric vehicle is decelerated at a relatively larger rate, regenerative electric power received from the motor 900 is relatively large; therefore, the controller 600 causes all of the three DC-DC converter circuits 101, 102, 103 to be driven. In the DC-DC converter circuit(s) that is/are not driven, out of the DC-DC converter circuits 101, 102, 103, the ON/OFF control of the switching devices are not performed by the controller 600 (i.e., the switching devices are constantly in the OFF state); thus, the DC-DC converter circuit that is not driven does not contribute to any power converting operation to raise or drop voltage.

Also, priorities are set on the respective DC-DC converter circuits. When the controller 600 changes the number of the DC-DC converter circuits to be driven, it preferentially drives the DC-DC converter circuit having the higher priority. In this embodiment, the first priority is given to the DC-DC converter circuit 101, and the second priority is given to the DC-DC converter circuit 102, while the third priority is given to the DC-DC converter circuit 103. When the number of the converter circuits to be driven is one, for example, the controller 600 drives the DC-DC converter circuit 101 having the highest priority. When the number of the converter circuits to be driven is two, the controller 600 drives the DC-DC converter circuit 101 having the first priority and the DC-DC converter circuit 102 having the second priority. Namely, among the DC-DC converter circuits 101, 102, 103, the DC-DC converter circuit 101 is driven at the highest frequency, and the DC-DC converter circuit 103 is driven at the lowest frequency.

The smoothing capacitor 650 is provided for smoothing the current of the battery 700. The smoothing capacitor 650 is connected at one terminal thereof to the input terminal T1a, and is connected at the other terminal to the output terminal T2b. Thus, the smoothing capacitor 650 is arranged in parallel with the battery 700.

Next, the specific operation of the DC-DC converter 100 to raise or drop voltage will be described.

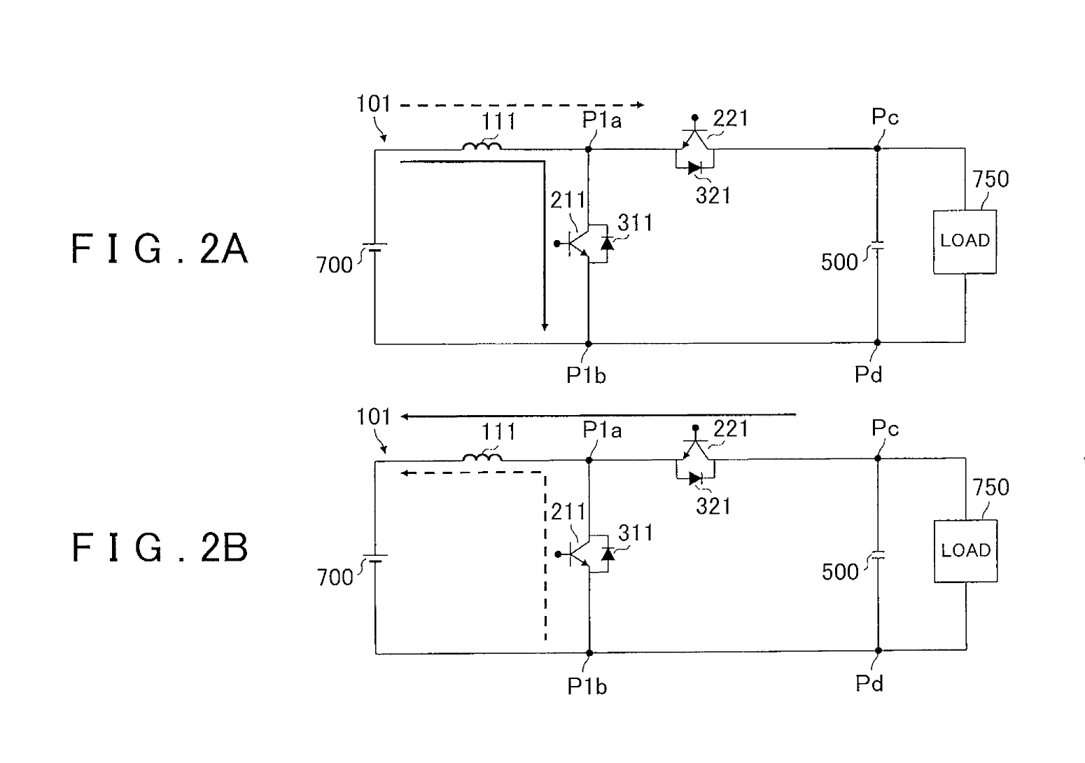

FIGS. 2A, 2B are circuit diagrams each showing the configuration of one phase of DC-DC converter circuit (DC-DC converter circuit 101) included in the DC-DC converter 100. FIG. 2A is used for explaining the operation of the DC-DC converter circuit 101 when it operates in the step-up mode. FIG. 2B is used for explaining the operation of the DC-DC converter circuit 101 when it operates in the step-down mode. Since the DC-DC converter circuits 101, 102, 103 connected in parallel have the same configuration, as described above, the specific operation of the DC-DC converter 100 to raise or drop voltage will be described using the DC-DC converter circuit 101.

Initially, the case where the DC-DC converter circuit 101 operates in the step-up mode will be explained. In this case, the switching device 221 is constantly placed in the OFF state.

Referring to FIG. 2A, when the switching device 211 is ON, electric current flows along a pathway indicated by the solid arrow. The voltage of the battery 700 is applied to the reactor 111, and current that flows in the reactor 111 increases according to the applied voltage. The rate of increase of the current is determined from the relationship of V1=L1×di1/dt, where L1 denotes the inductance of the reactor 111, i1 denotes the current flowing in the reactor 111, and V1 denotes the battery voltage. At this time, energy given by ½×L1×i1² is stored in the reactor 111. When the switching device 211 is then turned off (or switched to OFF), current flows along a pathway indicated by the dashed arrow in FIG. 2A. Since current cannot flow along the pathway of the solid arrow when the switching device 211 is OFF, the diode 321 is allowed to pass current due to the characteristic of the reactor 111 that tends to keep current flowing, and the current flows along the pathway indicated by the dashed arrow in FIG. 2A while the energy stored in the reactor 111 is released. At this time, the energy stored in the reactor 111 is superimposed on the electric power of the battery 700, so as to raise the voltage of the battery 700, and the resulting electric power is supplied to the load 750.

Next, the case where the DC-DC converter circuit 101 operates in the step-down mode will be explained. In this case, the switching device 211 is constantly placed in the OFF state.

Referring to FIG. 2B, when the switching device 221 is ON, current flows along a pathway indicated by the solid arrow. A voltage corresponding to a difference between the voltage between the output terminals T2a, T2b of the DC-DC converter 100 (voltage of regenerative power) and the voltage between the input terminals T1a, T1b (voltage of the battery 700) is applied to the reactor 111. The current flowing in the reactor 111 increases according to the voltage applied thereto. At this time, energy given by ½×L1×i1² is stored in the reactor 111. When the switching device 221 is then turned off (or switched to OFF), current flows through a pathway indicated by the dashed arrow in FIG. 2B. Since current cannot flow along the pathway of the solid arrow when the switching device 221 is OFF, the diode 311 is allowed to pass current due to the characteristic of the reactor 111 that tends to keep current flowing, and current flows along the pathway indicated by the dashed arrow in FIG. 2B while the energy stored in the reactor 111 is released. Namely, the voltage of the regenerative power is reduced based on the duty ratio of the ON/OFF control of the switching device 221, and the battery 700 is charged with the resulting regenerative power.

In the case of the step-up mode and the case of the step-down mode, when each of the switching devices 211, 221 is turned off, surge voltage corresponding to an inductance component included in wire traces, etc. is generated. In the following, the surge voltage generated upon turn-off of the switching device will be explained.

In the case of the step-up mode as shown in FIG. 2A, when the switching device 211 is ON, current flows along the pathway indicated by the solid arrow, and energy corresponding to the current is stored in the inductance component included in the wire traces, etc. between the connection points P1a, P1b. When the switching device 211 is turned off, the transition to the pathway indicated by the dashed arrow as described above is not immediately completed, and the energy transiently stored in the inductance component is released as current that flows in a closed circuit including the switching device 211 and the snubber capacitor 500. Also, in the case of the step-down mode as shown in FIG. 2B, when the switching device 221 is ON, current flows along the pathway indicated by the solid arrow, and energy corresponding to the current is stored in the inductance component included in the wire traces, etc. between the connection points P1a, Pc. When the switching device 221 is turned off, the transition to the pathway indicated by the dashed arrow as described above is not immediately completed, and the energy transiently stored in the inductance component is released as current that flows in a closed circuit including the switching device 221 and the snubber capacitor 500. It is thus possible to suppress the surge voltage generated in the switching devices 211, 221 to some extent, by releasing the energy stored in the inductor component of the wire traces, etc., through the closed circuit including the snubber capacitor 500. However, since an inductance component is also included in the closed circuit including the switching devices 211, 221 and the snubber capacitor 500, surge voltage is generated due to the inductance component. The DC-DC converter circuits 102, 103 also operate in the same manner as described above, and surge voltage is generated in the same manner.

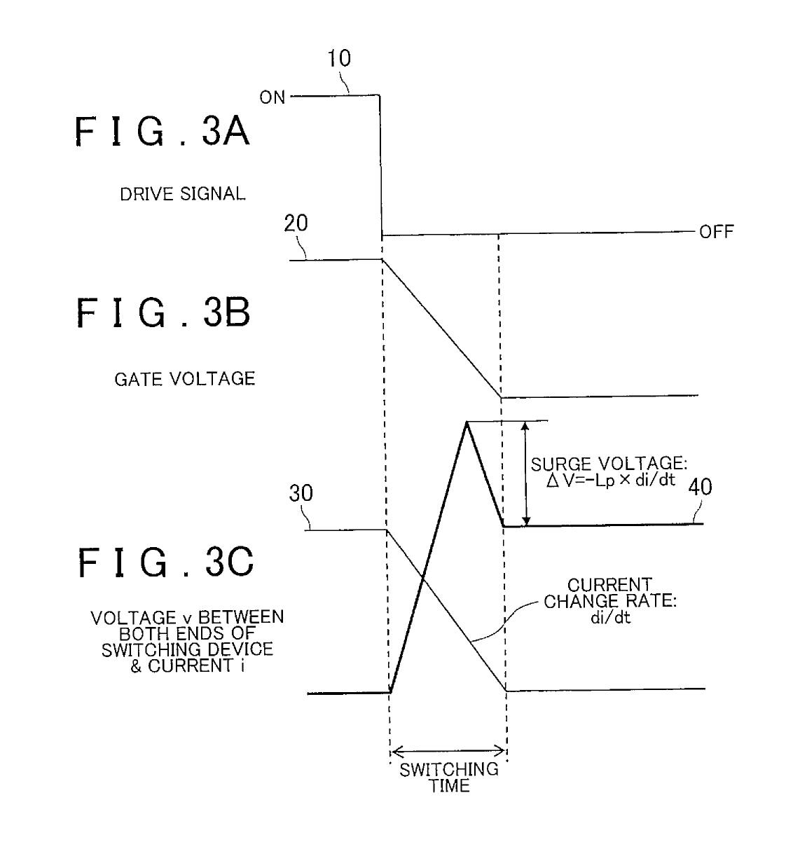

FIGS. 3A to 3C are used for explaining surge voltage generated in a certain switching device included in the DC-DC converter circuit. FIG. 3A indicates a drive signal of the switching device. FIG. 3B indicates the gate voltage corresponding to the drive signal. FIG. 3C indicates the voltage between both ends of the switching device, and the current flowing through the switching device, responsive to the drive signal and gate voltage of FIGS. 3A and 3B. The inductance of the inductance component of the closed circuit including the snubber capacitor 500 and the switching device will be called equivalent series inductance (ESL) of the closed circuit. In the following description using FIGS. 3A to 3C, any switching device selected from the switching devices 211, 221, 212, 222, 213, 223 will be simply called “switching device”.

When the drive signal of the switching device is switched from ON to OFF, as shown in FIG. 3A, the gate voltage indicated in FIG. 3B is not instantly reduced to the OFF voltage, but it requires a certain period of time (switching time) for the gate voltage to be reduced to the OFF voltage. Accordingly, the current Is of the switching device indicated in FIG. 3C is also not instantly reduced to zero, but it requires the switching time for the current Is to be reduced to zero. During the switching time, a surge voltage ΔV, in addition to the steady voltage E (voltage V1 of the battery 700 in the case of the step-up mode, voltage equal to a difference between the voltage V2 between the output terminals T2a, T2b (inverter 800) and V1 in the case of the step-down mode), is superimposed on the voltage Vs between the both ends of the switching device. The surge voltage ΔV is expressed by −Lp×dIs/dt, where Lp denotes ESL (equivalent series inductance) of the closed circuit including the snubber capacitor 500 and the switching device, and dIs/dt denotes the rate of change of the current of the switching device. The voltage obtained by adding the surge voltage ΔV to the steady voltage E is applied to the switching devices 211, 212, 213 in the case of the step-up mode, and is applied to the switching devices 221, 222, 223 in the case of the step-down mode.

As described above, it requires the switching time for the switching device to switch from ON to OFF, thus causing a switching loss. More specifically, the switching loss (power loss) is expressed by iₛ×vₛ, where iₛ denotes current flowing through the switching device at a given point in time, and vₛ denotes voltage between both ends of the switching device at the given point in time. The switching loss that appears upon turn-off of the switching device is obtained by integrating iₛ×vₛ over the switching time. Accordingly, when the surge voltage ΔV is small, the switching loss is reduced. Since the surge voltage ΔV is proportional to the ESL of the closed circuit including the snubber capacitor 500 and the switching device, as described above, the switching loss is reduced as the ESL is smaller.

Thus, in this embodiment, the snubber capacitor 500 is positioned in association with the ESL of each closed circuit including the switching devices included in each of the DC-DC converter circuits 101, 102, 103 and the snubber capacitor 500. More specifically, the snubber capacitor 500 is positioned so that the ESL of the closed circuit including the switching devices included in the DC-DC converter circuit that is more preferentially driven by the controller 600, i.e., the DC-DC converter circuit that is driven at the higher frequency, and the snubber capacitor 500, becomes smaller.

As described above, the first priority is given to the DC-DC converter circuit 101, the second priority is given to the DC-DC converter circuit 102, and the third priority is given to the DC-DC converter circuit 103. Accordingly, the snubber capacitor 500 is positioned so that the ESL of the closed circuit including the switching devices 211, 221 included in the DC-DC converter circuit 101 and the snubber capacitor 500 is minimized. Also, the snubber capacitor 500 is positioned so that the ESL of the closed circuit including the switching devices 213, 223 included in the DC-DC converter circuit 103 and the snubber capacitor 500 is maximized.

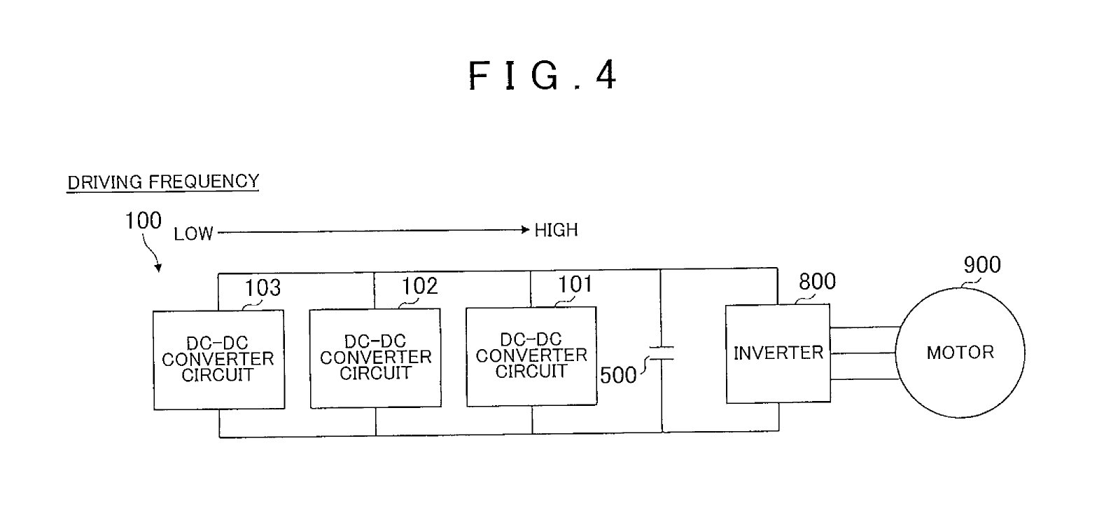

FIG. 4 is a schematic view showing the positional relationship between the DC-DC converter circuits 101, 102, 103 and the snubber capacitor 500 according to this embodiment.

In general, the ESL of the closed circuit becomes larger as the length of wire traces, etc. is larger; therefore, the snubber capacitor 500 may be preferably located at a position closest to the DC-DC converter circuit 101 that is driven at the highest frequency, as shown in FIG. 4. Also, the snubber capacitor 500 may be preferably located at a position farthest from the DC-DC converter circuit 103 that is driven at the lowest frequency. In this connection, the inductance component of wire traces, etc., can be cancelled by arranging positive (+) line and negative (−) line of wires (bus bars) in parallel with each other, for example; therefore, the ESL is not simply determined based on only the positional relationship between the snubber capacitor 500 and the DC-DC converter circuit. Accordingly, if the snubber capacitor 500 cannot be located at the position closest to the DC-DC converter circuit 101 that is driven at the highest frequency, for example, the ESL of the closed circuit including the switching devices 211, 221 and the snubber capacitor 500 may be minimized by locating the positive line and negative line of the wires (bus bars) in parallel with and in proximity to each other, for example.

Next, the efficiency of the DC-DC converter circuits 101, 102, 103 will be described.

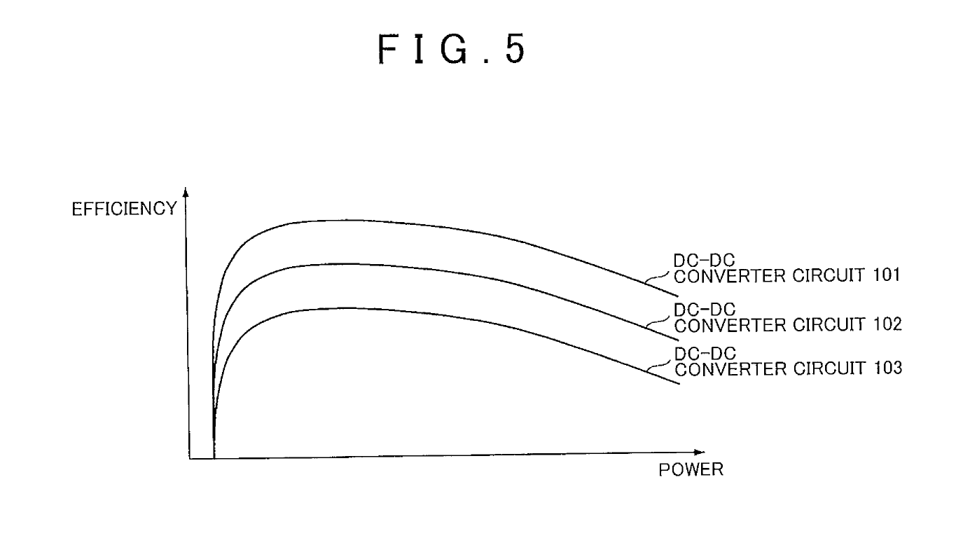

FIG. 5 is a graph showing one example of the efficiency of each of the DC-DC converter circuits 101, 102, 103.

Referring to FIG. 5, since the closed circuit including the switching devices 211, 221 included in the DC-DC converter circuit 101 that is driven at the highest frequency and the snubber capacitor 500 has the smallest ESL, the switching loss is small. Therefore, the DC-DC converter circuit 101 that is driven at the highest frequency has the highest efficiency. Since the closed circuit including the switching devices 213, 223 included in the DC-DC converter circuit 103 that is driven at the lowest frequency and the snubber capacitor 500 has the largest ESL, the switching loss is the largest. Therefore, the DC-DC converter circuit 103 that is driven at the lowest frequency has the lowest efficiency.

As described above, the controller 600 performs control for changing the number of the DC-DC converter circuits to be driven, according to the load of the motor 900, and preferentially drives the DC-DC converter circuit having the higher priority when changing the number. Namely, the DC-DC converter circuit having the higher priority is driven at the higher frequency. Accordingly, the practical efficiency of the DC-DC converter 100 can be improved, by positioning the snubber capacitor 500 so that the ESL of the closed circuit or loop including the switching devices included in the DC-DC converter circuit that is driven at the higher frequency and the snubber capacitor 500 becomes smaller. In particular, in the case where the DC-DC converter 100 of this embodiment is often used in a steady state where the output load or regenerative load is relatively small, like the motor 900 of the electric vehicle which supplies and receives electric power, the practical efficiency of the DC-DC converter 100 can be further improved.

In the above description, the snubber capacitor 500 is positioned in such a manner as to correspond to the frequency of driving the DC-DC converter circuits 101, 102, 103, thereby to improve the practical efficiency of the DC-DC converter 100. However, the respective DC-DC converter circuits 101, 102, 103 may be positioned relative to the snubber capacitor 500, so that the ESL of the closed circuit including the switching devices included in the DC-DC converter circuit that is driven at the higher frequency and the snubber capacitor 500 becomes smaller. In the case where there is a layout constraint on the position of the snubber capacitor 500, for example, the DC-DC converter circuit 101 that is driven at the highest frequency may be located closest to the snubber capacitor 500. Namely, the ESL of the closed circuit including the switching devices 211, 221 included in the DC-DC converter circuit 101 that is driven at the highest frequency and the snubber capacitor 500 may be made smaller than the ESLs of the closed circuits including the switching devices included in the other DC-DC converter circuits and the snubber capacitor 500.

Also, the controller 600 may perform drive control of the DC-DC converter circuits 101, 102, 103, in order to provide the same effect (improvement of the practical efficiency of the DC-DC converter 100). Namely, the controller 600 may perform drive control of the DC-DC converter circuits 101, 102, 103, so as to preferentially drive the DC-DC converter circuit including a part of the closed circuit having the smaller ESL, which is selected from the closed circuits including the switching devices 211, 221, 212, 222, 213, 223 and the snubber capacitor 500. For example, when there is no layout freedom in the DC-DC converter circuits 101, 102, 103, snubber capacitor 500, etc., the controller 600 performs the above-described drive control, so as to improve the practical efficiency of the DC-DC converter 100.

Also, the respective DC-DC converter circuits 101, 102, 103 may be positioned so that the DC-DC converter circuit that is driven at the higher frequency has the higher cooling efficiency. Namely, the DC-DC converter circuits 101, 102, 103 may be positioned so that the DC-DC converter circuit 101 having the highest priority has the highest cooling efficiency, and the DC-DC converter circuit 103 having the lowest priority has the lowest cooling efficiency. For example, the DC-DC converter circuit 101 may be located at a position at which the cooling efficiency can be enhanced, like a position close to an end portion of the DC-DC converter 100 or an inlet for cooling air or cooling water. With this arrangement, the DC-DC converter circuit having the higher cooling efficiency is preferentially driven. Since the efficiency of the DC-DC converter circuit is improved as its cooling efficiency is higher, the DC-DC converter circuit having the higher efficiency is driven at the higher frequency, and the practical efficiency of the DC-DC converter 100 can be further improved.

Next, a second embodiment of the invention will be described.

The snubber capacitor 500 according to this embodiment is positioned in association with the ESL of each closed circuit including the switching devices included in each of the DC-DC converter circuits 101, 102, 103 and the snubber capacitor 500, as in the first embodiment.

The second embodiment is mainly different from the first embodiment in that the snubber capacitor 500 is positioned so that each closed circuit has substantially the same ESL. In the following description, the same reference numerals are assigned to the same constituent elements as those of the first embodiment, and differences between the first and second embodiments will be mainly described.

Unlike the first embodiment, the controller 600 does not change the number of the DC-DC convert circuits to be driven, but constantly drives the three DC-DC converter circuits 101, 102, 103. However, the controller 600 may perform control for changing the number of the DC-DC converter circuits to be driven, as in the first embodiment.

As described above, the snubber capacitor 500 is positioned so that each closed circuit including the switching devices included in each of the DC-DC converter circuits 101, 102, 103 and the snubber capacitor 500 has substantially the same ESL. Namely, the closed circuit including the switching devices 211, 221 included in the DC-DC converter circuit 101 and the snubber capacitor 500 has substantially the same ESL as the closed circuit including the switching devices 212, 222 included in the DC-DC converter circuit 102 and the snubber capacitor 500. Also, the closed circuit including the switching devices 213, 223 included in the DC-DC converter circuit 103 and the snubber capacitor 500 has substantially the same ESL as the above-indicated closed circuits. The snubber capacitor 500 may be preferably positioned so that the ESL of each of the closed circuits as described above is further reduced.

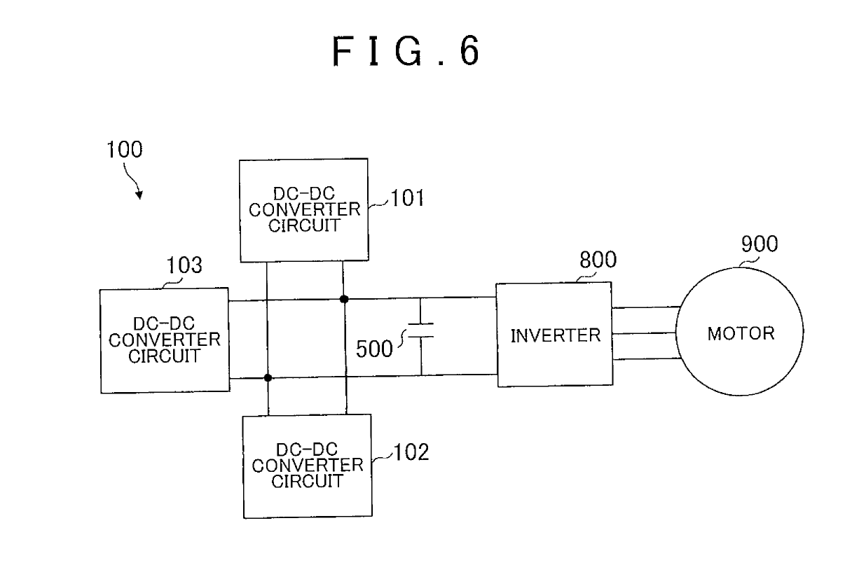

FIG. 6 is a schematic view showing the positional relationship between the DC-DC converter circuits 101, 102, 103 according to this embodiment, and the snubber capacitor 500.

Generally, the ESL of the closed circuit becomes larger as the length of wire traces, etc., is larger. Therefore, the snubber capacitor 500 may be preferably positioned, as shown in FIG. 6, so that the distance between each of the DC-DC converter circuits 101, 102, 103 and the snubber capacitor 500 becomes substantially equal. Also, each of the DC-DC converter circuits 101, 102, 103 and the snubber capacitor 500 may be preferably located closer to each other. Since the inductance component of wire traces, etc., can be cancelled by arranging positive (+) line and negative (−) line of wires (bus bars) in parallel with each other, for example, the ESL is not simply determined based on only the positional relationship between the snubber capacitor 500 and the DC-DC converter circuit. Accordingly, in the case where the distance between each of the DC-DC converter circuits and the snubber capacitor 500 cannot be made equal when they are mounted on a circuit board, the positive (+) line and negative (−) line of wires (bus bars) may be arranged in parallel with each other, for example, so that the above-indicated closed circuits have substantially the same ESL.

Thus, the ESL of each of the above-indicated closed circuits is made substantially equal, so that the efficiencies of the DC-DC converter circuits 101, 102, 103 can be improved overall. In particular, in the DC-DC converter 100 in which all of the three DC-DC converter circuits 101, 102, 103 are constantly driven, the snubber capacitor 500 is preferably positioned according to this embodiment, for improvement of the overall efficiency. With each ESL thus made equal, the same precondition is used for surge design between each of the DC-DC converter circuits 101, 102, 103 and the snubber capacitor 500, thus making it possible to largely reduce the amount of work required for surge adjustment (such as the optimization of the capacitance of the snubber capacitor 500).

For example, the adjustment task is only required to be performed only once (rather than three times) with respect to the DC-DC converter circuits 101, 102, 103; therefore, the amount of work required for surge adjustment can be reduced to about one third (⅓).

While each DC-DC converter circuit included in the DC-DC converter 100 is a non-isolated DC-DC converter circuit in the above-described embodiments, it may be any switching DC-DC convert circuit, such as an isolated DC-DC converter circuit.

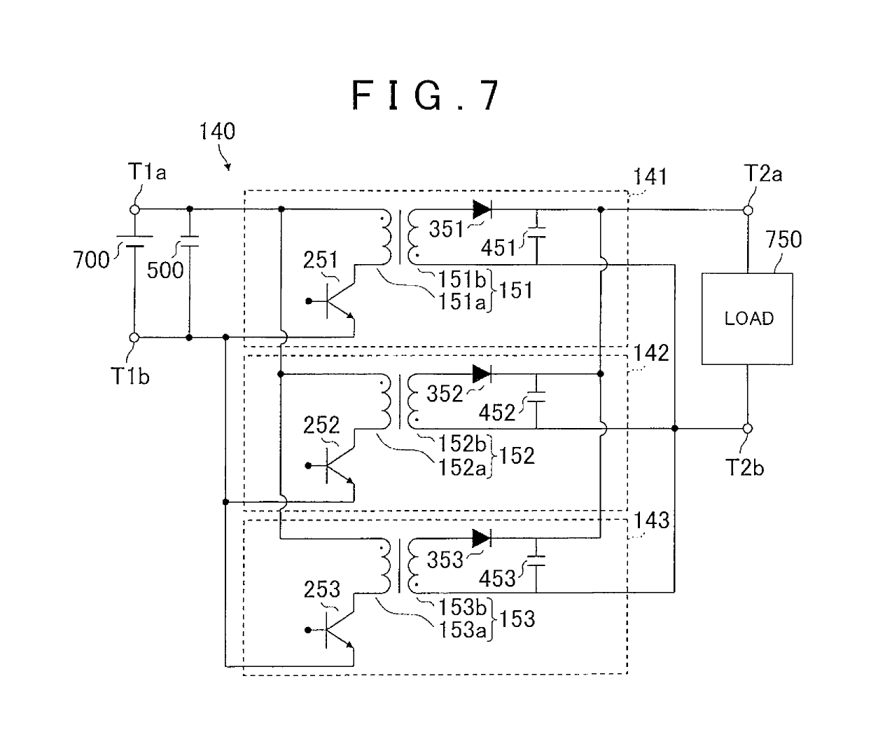

FIG. 7 is a circuit diagram showing a modified example of the DC-DC converter 100 according to the above-described embodiments. A DC-DC converter 140 according to the modified example raises the voltage of electric power received from the battery 700, and supplies the power to the load 750.

As in the first and second embodiments, the DC-DC converter 140 according to the modified example includes a pair of input terminals T1a, T1b, a pair of output terminals T2a, T2b, three DC-DC converter circuits 141, 142, 143 connected in parallel between the pair of input terminals T1a, T1b and the pair of output terminals T2a, T2b, snubber capacitor 500, controller 600, and so forth. The controller 600 is not illustrated in FIG. 7.

The DC-DC converter circuits 141, 142, 143 have the same configuration, and each of the DC-DC converter circuits 141, 142, 143 is an isolated DC-DC converter circuit called flyback converter.

The DC-DC converter circuit 141 includes a switching device 251, a transformer 151, a diode 351, a capacitor 451, and so forth. The DC-DC converter circuit 142 includes a switching device 252, a transformer 152, a diode 352, a capacitor 452, and so forth. The DC-DC converter circuit 143 includes a switching device 253, a transformer 153, a diode 353, a capacitor 453, and so forth.

Each of the transformers 151, 152, 153 includes a primary coil 151a, 152a, 153a, and a secondary coil 151b, 152b, 153b.

In the DC-DC converter circuit 141, when the switching device 251 is ON, electric current flows in a direction from the input terminal T1a toward the primary coil 151a, so that electromagnetic energy is stored in the transformer 151. At this time, no current flows in a circuit on the secondary coil 151b side, due to the relationship between the secondary coil 151b and the forward biased direction of the diode 351. When the switching device 251 is turned off, the diode 351 is allowed to pass current therethrough, and the energy stored in the transformer 151 is supplied to the load 750 via the output terminal T2a. The controller 600 performs ON/OFF control of the switching device 251, so as to raise the voltage of the power of the battery 700 and supplies the resulting power to the load 750. The DC-DC converter circuits 142, 143 also operate in the same manner to raise the voltage.

In the DC-DC converter 140 according to the modified example, the snubber capacitor 500 suppresses surge voltage generated in the switching devices 251, 252, 253 included in the DC-DC converter circuits 141, 142, 143, as in the first and second embodiments. The surge voltage generated upon turn-off of each of the switching devices 251, 252, 253 included in the DC-DC converter circuits 141, 142, 143 is proportional to the ESL (equivalent series inductance) Lp of each closed circuit including the switching device 251, 252, 253 and the snubber capacitor 500. Accordingly, in the DC-DC converter 140 according to the modified example, too, the snubber capacitor 500 may be positioned so that the ESL of the closed circuit including the switching device included in the DC-DC converter circuit that is driven at the higher frequency and the snubber capacitor 500 becomes smaller, as in the first embodiment. Namely, the ESL of the closed circuit including the switching device 251 included in the DC-DC converter circuit 141 and the snubber capacitor 500 may be made smaller than the ESLs of the closed circuits including the switching devices included in the other DC-DC converter circuits and the snubber capacitor 500. As in the first embodiment, the controller 600 preferentially drives the DC-DC converter circuit having the higher priority, and the DC-DC converter circuit 141 having the highest priority is driven at the highest frequency. With this arrangement, the DC-DC converter circuit with the higher efficiency is driven at the increased frequency, so that the practical efficiency of the DC-DC converter 140 can be improved.

Also, as in the first embodiment, the controller 600 may perform drive control of the DC-DC converter circuits 141, 142, 143, so as to preferentially drive the DC-DC converter circuit including a part of the closed circuit having the smaller ESL, which is selected from the closed circuits including the switching devices 251, 252, 253 and the snubber capacitor 500. For example, when there is no layout freedom in the DC-DC converter circuits 141, 142, 143, snubber capacitor 500, etc., the controller 600 performs the above-described drive control, so as to improve the practical efficiency of the DC-DC converter 140.

In the DC-DC converter 140 according to the modified example, each closed circuit including the switching device included in each of the DC-DC converter circuits 141, 142, 143 and the snubber capacitor 500 has substantially the same ESL, as in the second embodiment. Namely, the closed circuit including the switching device 251 included in the DC-DC converter circuit 141 and the snubber capacitor 500, and the closed circuit including the switching device 252 included in the DC-DC converter circuit 142 and the snubber capacitor 500 have substantially the same ESL. Also, the closed circuit including the switching device 253 included in the DC-DC converter circuit 143 and the snubber capacitor 500 has substantially the same ESL as the above-indicated closed circuits. Also, the snubber capacitor 500 may be preferably positioned so that substantially the same ESL of the above-indicated closed circuits is further reduced. With this arrangement, the efficiencies of the DC-DC converter circuits 141, 142, 143 can be improved overall. With each ESL thus made equal, the same precondition is used for surge design between each of the DC-DC converter circuits 141, 142, 143 and the snubber capacitor 500, thus making it possible to largely reduce the amount of work required for surge adjustment (such as the optimization of the capacitance of the snubber capacitor 500).

While some embodiments of the invention have been described in detail, the invention is not limited to any particular embodiment, but may be embodied with various modifications or changes, within the scope of the invention described in the appended claims.

While three DC-DC converter circuits are connected in parallel in the illustrated embodiments, more than three DC-DC converter circuits may be connected in parallel, or two DC-DC converter circuits may be connected in parallel.

In the illustrated embodiments, the snubber capacitor 500 is shared among all of the DC-DC converter circuits connected in parallel. However, the snubber capacitor 500 may be shared by at least two DC-DC converter circuits. Namely, the snubber capacitor 500 may be connected in parallel with the switching devices included in at least two DC-DC converter circuits, out of the two or more DC-DC converter circuits connected in parallel.

While the DC-DC converter circuits included in the DC-DC converter 100 or 140 are connected to the common power supply (battery 700) in the illustrated embodiments, the DC-DC converter circuits may be connected to different power supplies.

In the illustrated embodiments, the layout or configuration of the two or more DC-DC converter circuits connected in parallel and the snubber capacitor 500 shared by the DC-DC converter circuits is applied to the DC-DC converter 100 or 140. However, the above layout or configuration may be applied to any power conversion system, such as an AC-DC converter, for example.

What is claimed is:

1. A power conversion system, comprising:
a first switching DC-DC converter circuit including a first switching device;
a second switching DC-DC converter circuit connected in parallel with the first switching DC-DC converter circuit, the second switching DC-DC converter circuit including a second switching device; and
a snubber capacitor connected in parallel with each of the first switching device and the second switching device,
wherein the first switching DC-DC converter circuit, the second switching DC-DC converter circuit, and the snubber capacitor are configured such that a frequency of driving the first switching DC-DC converter circuit is higher than a frequency of driving the second switching DC-DC converter circuit, and an equivalent series inductance of a closed circuit including the first switching device and the snubber capacitor is smaller than an equivalent series inductance of a closed circuit including the second switching device and the snubber capacitor.

2. The power conversion system according to claim 1, further comprising a controller that performs drive control of the first switching DC-DC converter circuit and the second switching DC-DC converter circuit,
wherein the controller is configured to preferentially drive the first switching DC-DC converter circuit when driving at least one of the first switching DC-DC converter circuit and the second switching DC-DC converter circuit.

3. The power conversion system according to claim 1, wherein the power conversion system is installed on a mobile body, and supplies electric power to a device that drives the mobile body.

4. The power conversion system according to claim 1, wherein the first switching DC-DC converter circuit and the second switching DC-DC converter circuit are positioned so that the first switching DC-DC converter circuit has a higher cooling efficiency than the second switching DC-DC converter circuit.

5. The power conversion system according to claim 4, wherein the first switching DC-DC converter circuit is located in an end portion of the power conversion system.

6. A method of controlling a power conversion system including a first switching DC-DC converter circuit including a first switching device, a second switching DC-DC converter circuit connected in parallel with the first switching DC-DC converter circuit and including a second switching device, and a snubber capacitor connected in parallel with each of the first switching device and the second switching device, comprising:
when driving at least one of the first switching DC-DC converter circuit and the second switching DC-DC converter circuit, preferentially driving one of the first switching DC-DC converter circuit and the second switching DC-DC converter circuit including, as a part thereof, a closed circuit having a smaller equivalent series inductance, which is selected from a closed circuit including the first switching device and the snubber capacitor, and a closed circuit including the second switching device and the snubber capacitor.

7. A power conversion system, comprising:
a first switching DC-DC converter circuit including a first switching device;
a second switching DC-DC converter circuit connected in parallel with the first switching DC-DC converter circuit, the second switching DC-DC converter circuit including a second switching device; and
a snubber capacitor connected in parallel with each of the first switching device and the second switching device,
wherein the first switching DC-DC converter circuit, the second switching DC-DC converter circuit, and the snubber capacitor are configured such that an equivalent series inductance of a closed circuit including the first switching device and the snubber capacitor is substantially equal to an equivalent series inductance of a closed circuit including the second switching device and the snubber capacitor.
